(19) United States
(12) Patent Application Publication
(10) Pub. No.: US 2022/0298842 A1
(43) Pub. Date: Sep. 22, 2022

(54) CASEMENT WINDOW OPERATOR WITH ANTI-ROTATION FEATURE

(71) Applicant: WIND CORPORATION, Newtown, CT (US)

(72) Inventors: Patrick E. Wind, Darien, CT (US); Timothy Marshall, Wolcott, CT (US)

(21) Appl. No.: 17/696,451

(22) Filed: Mar. 16, 2022

Related U.S. Application Data
(60) Provisional application No. 63/162,036, filed on Mar. 17, 2021.

(51) Int. Cl. E05F 11/16; E05F 11/34

(52) U.S. Cl. CPC E05F 11/16; E05F 11/34; E05Y 2900/148

(57) ABSTRACT

A casement window operator, including: a first arm; a second arm, the first arm and the second arm each being rotatably mounted to the casement window operator and the first arm and the second arm each having a toothed peripheral portion for meshingly engaging a worm rotatably received in the casement window operator, such that rotation of the worm about its axis of rotation will cause the first arm and the second arm to rotate with respect to the casement window operator; and a damper located between the worm and a housing of the casement window operator, wherein the damper has a pair of anti-rotation features each being located about an exterior peripheral portion of the damper, the pair of anti-rotation features extending outwardly from the exterior peripheral portion of the damper and wherein the pair of anti-rotation features are configured to be received within a corresponding pair of openings of the housing of the casement window operator.

### CROSS REFERENCE TO RELATED APPLICATIONS

The application claims the benefit of U.S. Provisional Patent Application No. 63/162,036 filed on Mar. 17, 2021, the entire contents of which are incorporated herein by reference thereto.

### BACKGROUND

Exemplary embodiments of the present disclosure pertain to casement window operators and in particular, a casement window operator with an anti-rotation feature.

Undesirable movement of arms of the casement window operator may be caused by conditions such as vibration and/or wind that may act upon the casement window operator and/or windows secured to the arms of the casement window operator.

Accordingly, it is desirable to provide the casement window operator with an anti-rotation feature.

### BRIEF DESCRIPTION

Disclosed is a casement window operator, including: a first arm; a second arm, the first arm and the second arm each being rotatably mounted to the casement window operator and the first arm and the second arm each having a toothed peripheral portion for meshingly engaging a worm rotatably received in the casement window operator, such that rotation of the worm about its axis of rotation will cause the first arm and the second arm to rotate with respect to the casement window operator; and a damper located between the worm and a housing of the casement window operator, wherein the damper has a pair of anti-rotation features each being located about an exterior peripheral portion of the damper, the pair of anti-rotation features extending outwardly from the exterior peripheral portion of the damper and wherein the pair of anti-rotation features are configured to be received within a corresponding pair of openings of the housing of the casement window operator.

In addition to one or more of the features described above, or as an alternative to any of the foregoing embodiments, the damper is located about a peripheral portion of the worm and one of the pair of openings is located in a lower housing portion of the casement window operator and the other one of the openings is located in an upper housing portion of the casement window operator.

In addition to one or more of the features described above, or as an alternative to any of the foregoing embodiments, the pair of anti-rotation features and their corresponding pair of openings have a rectangular shape.

In addition to one or more of the features described above, or as an alternative to any of the foregoing embodiments, the pair of anti-rotation features and their corresponding pair of openings have a rectangular shape.

In addition to one or more of the features described above, or as an alternative to any of the foregoing embodiments, the damper has a waved interior surface that is configured to match a waved exterior surface of the worm.

In addition to one or more of the features described above, or as an alternative to any of the foregoing embodiments, the waved interior surface of the damper has the same wavelength and amplitude as the waved exterior surface of the worm or worm drive.

In addition to one or more of the features described above, or as an alternative to any of the foregoing embodiments, the damper has a waved interior surface that is configured to match a waved exterior surface of the worm.

In addition to one or more of the features described above, or as an alternative to any of the foregoing embodiments, the waved interior surface of the damper has the same wavelength and amplitude as the waved exterior surface of the worm or worm drive.

In addition to one or more of the features described above, or as an alternative to any of the foregoing embodiments, the pair of anti-rotation features and their corresponding pair of openings have a rectangular shape.

In addition to one or more of the features described above, or as an alternative to any of the foregoing embodiments, the damper is formed from an elastomeric material.

In addition to one or more of the features described above, or as an alternative to any of the foregoing embodiments, the damper is formed from an elastomeric material.

Also disclosed is a casement window operator, including: a first arm; a second arm, the first arm and the second arm each being rotatably mounted to the casement window operator and the first arm and the second arm each having a toothed peripheral portion for meshingly engaging a worm rotatably received in the casement window operator, such that rotation of the worm about its axis of rotation will cause the first arm and the second arm to rotate with respect to the casement window operator; and a spring damper located between the worm and a housing of the casement window operator, wherein the spring damper has at least one anti-rotation feature located about an exterior peripheral portion of the spring damper, the at least one anti-rotation feature extending outwardly from the exterior peripheral portion of the spring damper and wherein the at least one anti-rotation feature is configured to be received within an opening of the housing of the casement window operator.

In addition to one or more of the features described above, or as an alternative to any of the foregoing embodiments, the spring damper has a free end proximate to the at least one anti-rotation feature.

Also disclosed is a method of providing an anti-rotation feature to a casement window operator, the method including the steps of: rotatably mounting a first arm and a second arm to a housing of the casement window operator; rotatably mounting a worm to the housing of the casement window operator, the first arm and the second arm each having a toothed peripheral portion for meshingly engaging the worm, such that rotation of the worm about its axis of rotation will cause the first arm and the second arm to rotate with respect to the casement window operator; and locating a damper between the worm and the housing of the casement window operator, wherein the damper has a pair of anti-rotation features each being located about an exterior peripheral portion of the damper, the pair of anti-rotation features extending outwardly from the exterior peripheral portion of the damper and wherein the pair of anti-rotation features are configured to be received within a corresponding pair of openings of the housing of the casement window operator.

In addition to one or more of the features described above, or as an alternative to any of the foregoing embodiments, the damper is located about a peripheral portion of the worm and one of the pair of openings is located in a lower housing portion of the casement window operator and the other one of the openings is located in an upper housing portion of the casement window operator.

In addition to one or more of the features described above, or as an alternative to any of the foregoing embodiments, the pair of anti-rotation features and their corresponding pair of openings have a rectangular shape.

In addition to one or more of the features described above, or as an alternative to any of the foregoing embodiments, the damper has a waved interior surface that is configured to match a waved exterior surface of the worm and wherein the waved interior surface of the damper has the same wavelength and amplitude as the waved exterior surface of the worm or worm drive.

In addition to one or more of the features described above, or as an alternative to any of the foregoing embodiments, the damper has a waved interior surface that is configured to match a waved exterior surface of the worm and wherein the waved interior surface of the damper has the same wavelength and amplitude as the waved exterior surface of the worm or worm drive.

### BRIEF DESCRIPTION OF THE DRAWINGS

The following descriptions should not be considered limiting in any way. With reference to the accompanying drawings, like elements are numbered alike:

FIGS. 1A and 1B are perspective views of a casement window operator in accordance with the present disclosure;

FIG. 2 is a top view of the casement window operator illustrated in FIG. 1;

FIG. 3 is a view along lines 3-3 of FIG. 2;

FIG. 4 is a perspective view of a bottom housing portion of a casement window operator in accordance with the present disclosure;

FIG. 5A is a perspective view of a damper for a casement window operator in accordance with the present disclosure;

FIG. 5B is a view of a damper for a casement window operator in accordance with the present disclosure;

FIG. 5C is a view of a portion of a damper for a casement window operator in accordance with the present disclosure;

FIG. 6 is a perspective view of a worm for a casement window operator in accordance with the present disclosure;

FIG. 7 is a view of a worm for a casement window operator in accordance with the present disclosure;

FIG. 8 is a view along lines 8-8 of FIG. 7;

FIG. 9 is view of portions of a worm for a casement window operator in accordance with the present disclosure;

FIG. 10 is a perspective view of an alternative damper for use with a casement window operator in accordance with the present disclosure;

FIG. 11 is a perspective view of a portion of a worm of the casement window operator; and

FIG. 12 is a perspective view of the alternative damper located on a portion of a worm of the casement window operator.

### DETAILED DESCRIPTION

A detailed description of one or more embodiments of the disclosed apparatus and method are presented herein by way of exemplification and not limitation with reference to the Figures.

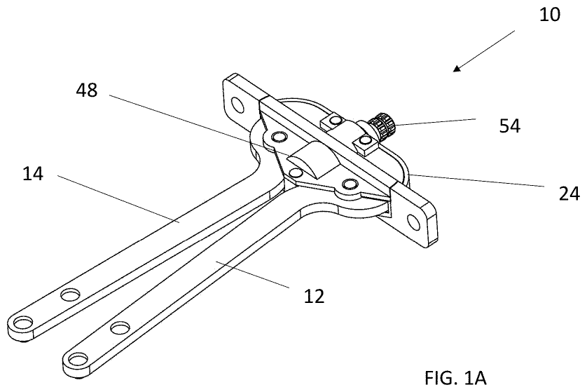

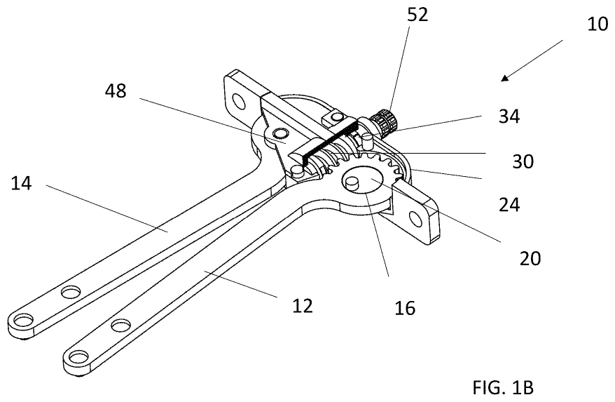

Referring now to FIGS. 1A and 1B a casement window operator 10 in accordance with the present disclosure is illustrated. The casement window operator 10 includes a first or right arm 12 and a second or left arm 14. As is known in the related arts the first or right arm 12 and the second or left arm 14 are secured to windows (not shown) in order to provide the desired movement of the windows.

The first or right arm 12 and the second or left arm 14 are each rotatably mounted to the casement window operator 10. For example, the first or right arm 12 and the second or left arm 14 each have an opening 16 for rotatably receiving a corresponding protrusion 20, 22 of a lower housing portion 24 of the casement window operator 10.

Each of the first or right arm 12 and the second or left arm 14 also have a geared or toothed peripheral portion 26, 28 for meshingly engaging a worm or worm drive 30. The worm 30 is rotatably received in the casement window operator 10 such that rotation of the worm 30 about its axis of rotation will cause the first or right arm 12 and the second or left arm 14 to move in the directions of arrows 32.

In order to prevent undesirable movement or rotation of the worm 30 and thus undesirable movement of the first or right arm 12 and the second or left arm 14, a damper 34 is provided in the casement window operator 10. This undesired movement may be caused by conditions such as vibration and/or wind that may act upon the casement window operator 10 and/or the windows secured to the first or right arm 12 and the second or left arm 14.

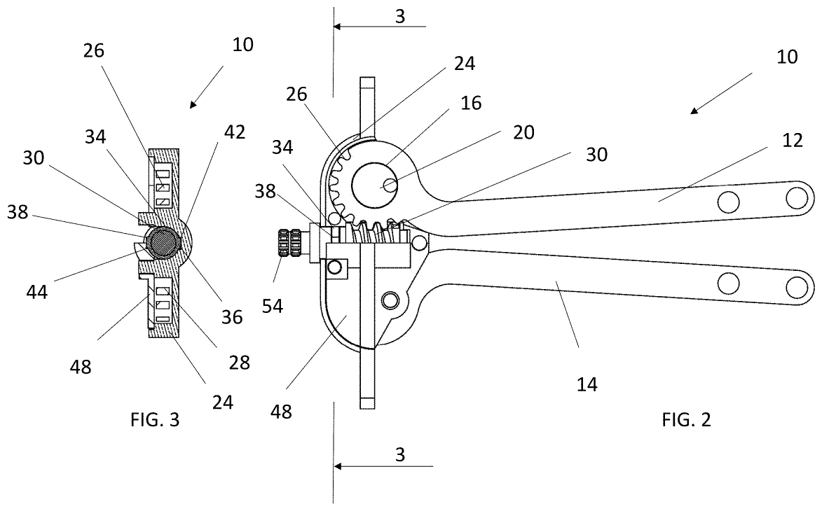

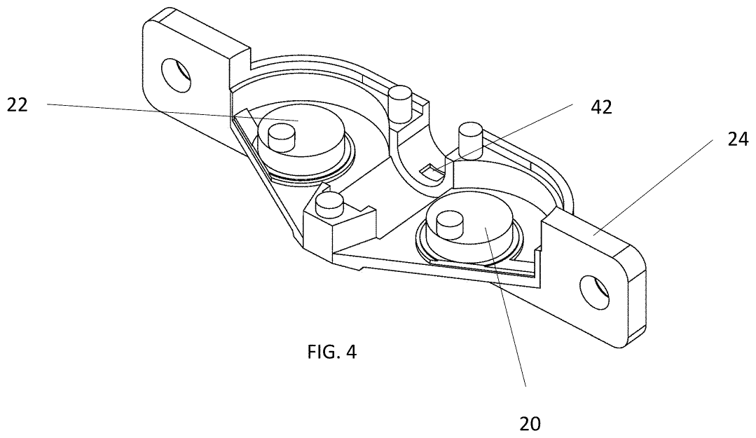

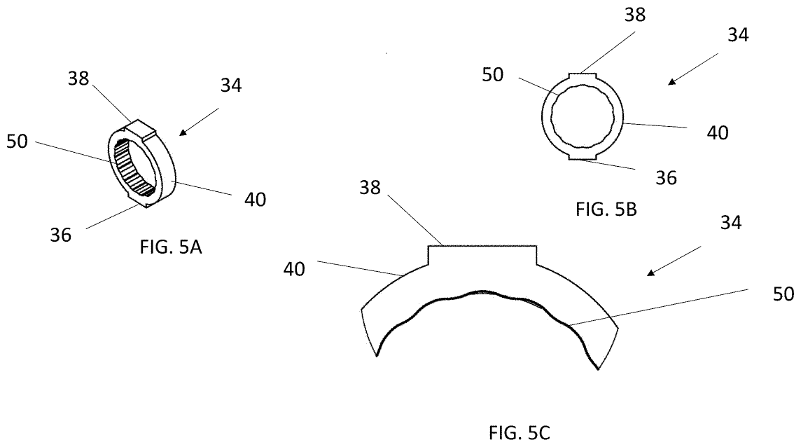

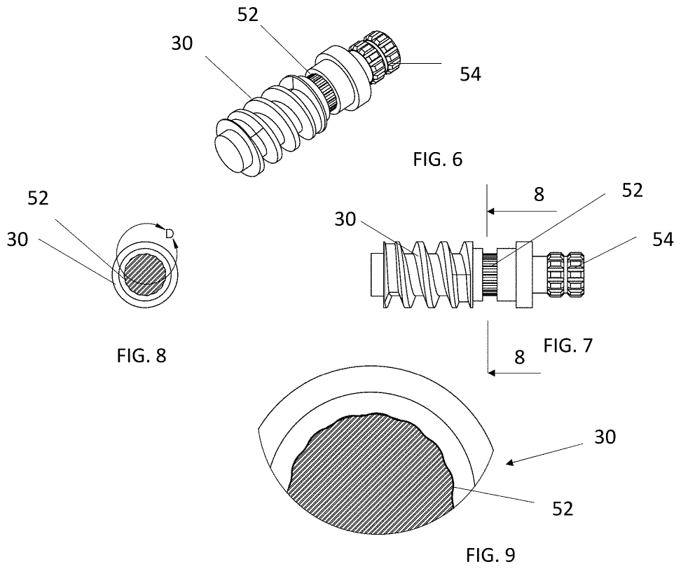

The damper 34 is located about a peripheral portion of the worm and has a pair of anti-rotation features 36, 38 each being located about an exterior peripheral portion 40 of the damper. The pair of anti-rotation features 36, 38 extend outwardly or radially from the exterior peripheral portion 40 of the damper 34 and are configured to be received within a corresponding pair of openings or recesses 42, 44 of a housing of the casement window operator 10. In one embodiment, one of the pair of openings or recesses 42 is located in the lower housing portion 24 of the casement window operator 10 and the other one of the pair of openings or recesses 44 is located in an upper housing portion 48 of the casement window operator 10. Note: a portion of the upper housing portion 48 is removed in FIGS. 1B, 2 and 3. Alternatively, the damper 34 may have more or less than a pair of anti-rotation features 36, 38. In other words, the damper may have more than two anti-rotation features or only one anti-rotation feature and corresponding openings or recesses for the anti-rotation feature(s).

The pair of anti-rotation features 36, 38 and their corresponding pair of openings or recesses 42 may have any suitable shape such as but not limited to square, rectangle, circle, circular, ellipse, triangle, star, cross or any equivalent structure.

The damper 34 also has a waved interior surface 50 that is configured to match a waved exterior surface 52 of the worm or worm drive 30. In one embodiment, the waved interior surface 50 of the damper 34 has the same wavelength and amplitude as the waved exterior surface 52 of the worm or worm drive 30. As such and when the damper 34 is located upon the worm or worm drive 30 and when the damper 34 and the worm or worm drive 30 are located between the upper housing portion 48 and the lower housing portion 24, the anti-rotation features 36, 38 and their corresponding openings 42 as well as the waved interior surface 50 damper 34 and the waved exterior surface 52 of the worm or worm drive 30 will provide an anti-rotation feature that will prevent undesirable movement of the worm or worm drive 30 which may be due to vibration and/or wind that may act upon the casement window operator 10 and/or the windows secured to the first or right arm 12 and the second or left arm 14.

In one non-limiting embodiment, the damper 34 may be formed from an elastomeric material such as rubber and equivalents thereof such that the damper can stretched so it can be placed upon the worm or worm drive 30 and then due its elastomeric properties the damper 34 returns to its undeformed shape once it is installed on the worm or worm drive 30. Alternatively, the damper 34 may be formed from metal, an alloy, plastic or equivalent materials where the damper can be deformed for installation on the worm 30 and then return to its undeformed configuration once it is installed on the worm 30. Also and as desired, the durometer of the damper 34 may be varied. Still further, the amplitude and wavelength of the waved interior surface 50 and the waved exterior surface 52 may be varied as desired.

A distal end 54 of the worm or worm drive 30 is configured to be secured to a handle (not shown), which when operated will rotate the worm or worm drive 30 and cause it to overcome the anti-rotational forces provided between the damper 34 and the worm 30 and thus cause a corresponding movement of the windows secured to the first or right arm 12 and the second or left arm 14. For example, the anti-rotation features 36, 38 of the damper 34 will remain in their corresponding pair of openings or recesses 42 while the waved interior surface 50 will slide about the waved exterior surface 52 of the worm or worm drive 30 as it rotated by a handle secured to the distal end 54 of the worm or worm drive 30. In other words, the frictional engagement between the anti-rotation features 36, 38 and their corresponding pair of openings or recesses 42 is greater than the frictional engagement between the waved interior surface 50 and the waved exterior surface 52 of the worm or worm drive 30 such that the worm or worm drive 30 will rotate with respect to the damper 34 prior to rotation of the damper 34 with respect to the upper housing portion 48 and the lower housing portion 24. Thus and when a rotational force is allied to the distal end 54 of the worm or worm drive 30, the worm or worm drive 30 will rotate while the damper 34 will remain stationary.

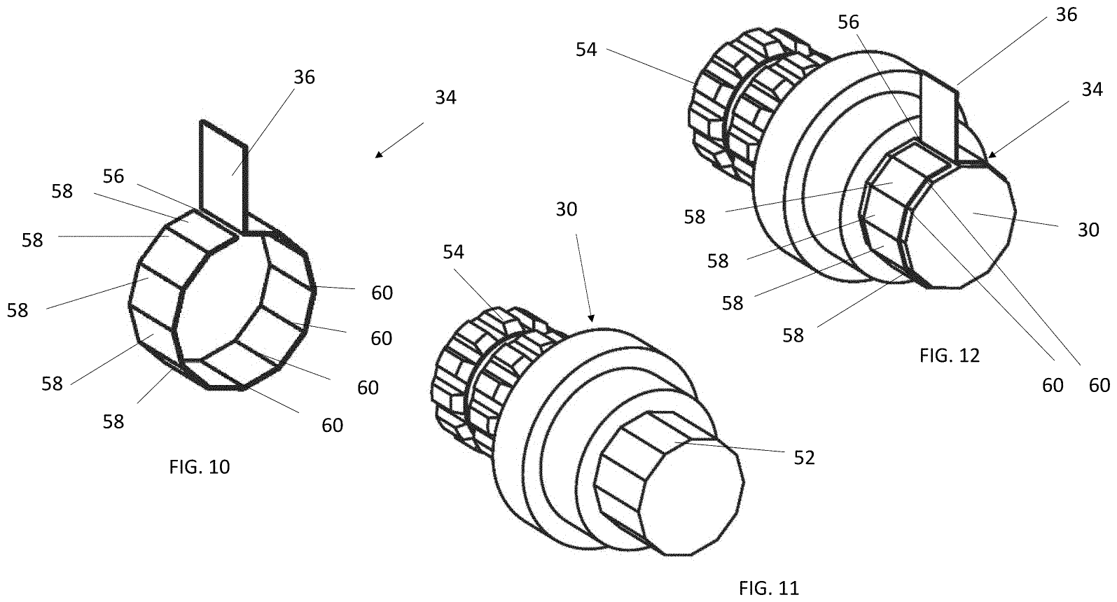

Referring now to FIGS. 10-12 an alternative embodiment of the present disclosure is provided. Here the damper 34 may be configured as a spring formed from a deformable material such as metal, steel, metal alloys, plastic, and equivalents thereof such that the damper 34 can be deformed for installation on the worm 30 and then returned to its undeformed configuration once it is installed on the worm 30. In this embodiment, the damper 34 may have a free end 56 that terminates proximate to an anti-rotation feature 36. Here the damper 34 may have a single anti-rotation feature 36 configured for receipt in a corresponding opening of the upper 48 or lower housing portion 24. Alternatively, the damper 34 may have a pair of anti-rotation features 36, 38 configured for receipt in a corresponding pair of openings or recesses 42, 44. Alternatively, the damper 34 may have more or less than a pair of anti-rotation features 36, 38. In other words, the damper may have more than two anti-rotation features or only one anti-rotation feature and corresponding openings or recesses for the anti-rotation feature(s).

In this embodiment, the damper 34 may have a plurality of waves or flats 58 that define a plurality of self-locking increments 60. In the illustrated embodiment, twelve waves or flats 58 are illustrated however the number of waves or flats 58 may be greater than or less than twelve. As the number of waves or flats 58 increases or decreases the corresponding number of self-locking increments 60 increase of decrease. In FIG. 11 a corresponding portion of the worm or worm drive 30 is illustrated, wherein the exterior surface 52 of the worm or worm drive 30 is configured to match the corresponding number of self-locking increments 60. FIG. 12 illustrates a portion of the worm or worm drive 30 with the damper 34 of FIG. 10 located thereon.

In this embodiment the spring thickness and hardness of the damper 34 may be altered to achieve the desired anti-rotation characteristics.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A casement window operator, comprising:
a first arm;
a second arm, the first arm and the second arm each being rotatably mounted to the casement window operator and the first arm and the second arm each having a toothed peripheral portion for meshingly engaging a worm rotatably received in the casement window operator, such that rotation of the worm about its axis of rotation will cause the first arm and the second arm to rotate with respect to the casement window operator; and
a damper located between the worm and a housing of the casement window operator, wherein the damper has a pair of anti-rotation features each being located about an exterior peripheral portion of the damper, the pair of anti-rotation features extending outwardly from the exterior peripheral portion of the damper and wherein the pair of anti-rotation features are configured to be received within a corresponding pair of openings of the housing of the casement window operator.

2. The casement window operator as in claim 1, wherein the damper is located about a peripheral portion of the worm and one of the pair of openings is located in a lower housing portion of the casement window operator and the other one of the openings is located in an upper housing portion of the casement window operator.

3. The casement window operator as in claim 2, wherein the pair of anti-rotation features and their corresponding pair of openings have a rectangular shape.

4. The casement window operator as in claim 1, wherein the pair of anti-rotation features and their corresponding pair of openings have a rectangular shape.

5. The casement window operator as in claim 1, wherein the damper has a waved interior surface that is configured to match a waved exterior surface of the worm.

6. The casement window operator as in claim 5, wherein the waved interior surface of the damper has the same wavelength and amplitude as the waved exterior surface of the worm or worm drive.

7. The casement window operator as in claim 2, wherein the damper has a waved interior surface that is configured to match a waved exterior surface of the worm.

8. The casement window operator as in claim 7, wherein the waved interior surface of the damper has the same wavelength and amplitude as the waved exterior surface of the worm or worm drive.

9. The casement window operator as in claim 8, wherein the pair of anti-rotation features and their corresponding pair of openings have a rectangular shape.

10. The casement window operator as in claim 1, wherein the damper is formed from an elastomeric material.

11. The casement window operator as in claim 2, wherein the damper is formed from an elastomeric material.

12. The casement window operator as in claim 3, wherein the damper is formed from an elastomeric material.

13. The casement window operator as in claim 4, wherein the damper is formed from an elastomeric material.

14. A casement window operator, comprising:
a first arm;
a second arm, the first arm and the second arm each being rotatably mounted to the casement window operator and the first arm and the second arm each having a toothed peripheral portion for meshingly engaging a worm rotatably received in the casement window operator, such that rotation of the worm about its axis of rotation will cause the first arm and the second arm to rotate with respect to the casement window operator; and
a spring damper located between the worm and a housing of the casement window operator, wherein the spring damper has at least one anti-rotation feature located about an exterior peripheral portion of the spring damper, the at least one anti-rotation feature extending outwardly from the exterior peripheral portion of the spring damper and wherein the at least one anti-rotation feature is configured to be received within an opening of the housing of the casement window operator.

15. The casement window operator as in claim 14, wherein the spring damper has a free end proximate to the at least one anti-rotation feature.

16. A method of providing an anti-rotation feature to a casement window operator, comprising:
rotatably mounting a first arm and a second arm to a housing of the casement window operator;
rotatably mounting a worm to the housing of the casement window operator, the first arm and the second arm each having a toothed peripheral portion for meshingly engaging the worm, such that rotation of the worm about its axis of rotation will cause the first arm and the second arm to rotate with respect to the casement window operator; and
locating a damper between the worm and the housing of the casement window operator, wherein the damper has a pair of anti-rotation features each being located about an exterior peripheral portion of the damper, the pair of anti-rotation features extending outwardly from the exterior peripheral portion of the damper and wherein the pair of anti-rotation features are configured to be received within a corresponding pair of openings of the housing of the casement window operator.

17. The method as in claim 16, wherein the damper is located about a peripheral portion of the worm and one of the pair of openings is located in a lower housing portion of the casement window operator and the other one of the openings is located in an upper housing portion of the casement window operator.

18. The method as in claim 17, wherein the pair of anti-rotation features and their corresponding pair of openings have a rectangular shape.

19. The method as in claim 16, wherein the damper has a waved interior surface that is configured to match a waved exterior surface of the worm and wherein the waved interior surface of the damper has the same wavelength and amplitude as the waved exterior surface of the worm or worm drive.

20. The method as in claim 17, wherein the damper has a waved interior surface that is configured to match a waved exterior surface of the worm and wherein the waved interior surface of the damper has the same wavelength and amplitude as the waved exterior surface of the worm or worm drive.
